(19) United States
(12) Patent Application Publication
(10) Pub. No.: US 2002/0112400 A1
(43) Pub. Date: Aug. 22, 2002

(54) Assembly for training plants, in particular vines

(76) Inventor: Alain Fidler, Fontenay Aux Roses (FR)

Correspondence Address: NIXON & VANDERHYE P.C., 8th Floor, 1100 North Glebe Road, Arlington, VA, 22201, US

(21) Appl. No.: 10/066,792

(22) Filed: Feb. 6, 2002

(30) Foreign Application Priority Data
Feb. 9, 2001 (FR) 0101798

(51) Int. Cl. A01G 17/06; A01G 17/14

(52) U.S. Cl. 47/46

(57) ABSTRACT

A training assembly, in particular for vines, the assembly comprising at least two end stakes, a plurality of intermediate metal stakes, supporting crossbars mounted on the intermediate stakes, and moving or fixed support wires extending from one end stake to the other and being supported by the crossbars mounted on the intermediate stakes at heights that are adjusted to be in alignment from one stake to the next. The crossbars are single-piece crossbars, the material of the crossbars is elastically deformable, and the respective profiles of the crossbars and of the intermediate stakes are selected in such a manner as to enable the crossbars to be snap-fastened onto a stake, the crossbar being mounted on a stake by elastically deforming the crossbar by applying external stress thereto, and once the crossbar has been put into position at a selected height on the stake, the crossbar is held to the stake by the elastic return force once the external stress has been released.

The invention relates to an assembly for training plants.

Most advantageously it applies to training vines and it is described in that context, however that application is not limiting and it will be understood that the invention is equally applicable to training other plants and shrubs whenever it is desirable to extend and tie up plant branches or canes thereof so as to impose a determined direction on them.

### BACKGROUND OF THE INVENTION

Traditionally, vines have been trained by setting out a series of stakes made of wood, of stainless or galvanized steel, or of plastics material, and having wires for supporting vine branches fixed thereto at the required height, and referred to as “support wires”.

FR-A-2 556 775 thus describes a stake provided with a series of holes enabling it to hold a wire at different predetermined heights.

Support wires can also be connected to stakes by means of supporting crossbars or fasteners removably or permanently fixed to the stakes.

The invention relates more particularly to training systems in which the stakes are metal stakes carrying support crossbars that have holes for receiving the wires.

The crossbars can be fixed to the stakes in various ways.

A first technique consists in fixing the crossbars by bolting them to the stakes which are perforated at the height where a crossbar is to be mounted. That technique provides fixing that is robust and that can subsequently be dismantled, however it is lengthy and expensive to implement since the stakes must initially all have holes made therein. In addition, tooling is required for bolting a crossbar onto a stake. Finally, the height of the strip relative to the ground is determined by the position of the hole in the stake, which means that its height cannot subsequently be readjusted unless additional holes are drilled in the stakes or unless the stakes are originally made with a large number of holes, which would increase cost considerably.

Another technique consists in providing crossbars having arms that can be bent. A crossbar is then clamped to a stake at the desired height by plastically deforming its deformable portions so that they pinch the stake. This avoids the need to make a hole in the stake, and the height at which the crossbar is installed can be adjusted freely. Nevertheless, that technique suffers from the drawback of not being reversible (the crossbars can be removed, but not reused) and it is still necessary to make use of tooling when putting the crossbars into place. Finally, height cannot be readjusted other than by using new crossbars to replace the old crossbars.

EP-A-0 141 469 describes yet another technique in which each crossbar comprises a releasable assembly made up of two distinct pieces that can be engaged one in the other by wedging. The two pieces have matching grooves which enable them to slide one in the other and the grooves are not exactly parallel but are slightly inclined so as to become jammed by force at the end of a stroke. Furthermore, that one of the two pieces of a crossbar which surrounds the stake is deformable so that it can be put into place around the stake, but in order to be able to hold the assembly on the stake at a selected height it is necessary to push in the complementary piece that enables forced jamming to take place. That crossbar is effective, but it is particularly expensive to make: it requires molded parts to be made out of plastics material to tolerances that are quite precise and using material of well-controlled quality so as to ensure that the wedging is effective and durable in spite of the plastics material aging under the effect of bad weather and temperature cycling. Manufacturing costs makes such a system unsuitable for use on a large scale such as in vineyards which can cover several hectares or tens of hectares.

### OBJECT AND SUMMARY OF THE INVENTION

The object of the invention is to remedy the above-described drawbacks by proposing a stake and crossbar training assembly which is simultaneously very inexpensive to produce, simple to set up (no tooling required), and easy and quick to readjust in height without degrading the mechanical properties of a crossbar or of the bonding between a crossbar and a stake.

The training assembly of the invention is an assembly of the above-specified type made of metal elements, i.e. comprising, more particularly, at least two end stakes, a plurality of intermediate metal stakes, supporting crossbars mounted on the intermediate stakes, and moving or fixed support wires extending from one end stake to the other and being supported by the crossbars mounted on the intermediate stakes at heights that are adjusted to be in alignment from one stake to the next.

Essentially, the invention consists in providing a crossbar in the form of a one-piece “clip-crossbar” of elastically deformable material which means that it can be put into place on the stake merely by clipping or snap-fastening, using the elasticity of its material. Under such circumstances, clip-crossbars can be moved at will in order to achieve finer adjustment in height so as to ensure that the support wires are properly aligned.

More precisely, in the assembly of the invention, the crossbars are single-piece crossbars, the material of the crossbars is elastically deformable, and the respective profiles of the crossbars and of the intermediate stakes are selected in such a manner as to enable the crossbars to be snap-fastened onto a stake, the crossbar being mounted on a stake by elastically deforming the crossbar by applying external stress thereto, and once the crossbar has been put into position at a selected height on the stake, the crossbar is held to the stake by the elastic return force once the external stress has been released.

Advantageously, the intermediate and/or end stakes are metal bars of uniform section.

Preferably, the intermediate stakes are symmetrical angle sections, and preferably they include tapering ends to make it easier to engage crossbars over their ends.

The crossbar is advantageously of omega-shaped section, with the limbs of the omega shape including holes suitable for supporting the support wires, and with its web having a central portion and angled portions which together present an internal profile matching the internal profile of an intermediate stake. In particular, the dihedral angle of a bar constituting an intermediate stake is greater than the angle defined by the angled portions of the web of a crossbar.

An end stake can be a post of square section extended from two opposite corners by straight flanges projecting away from each other in a common plane, an end stake being provided in at least one of the flanges with perforations suitable for enabling a support wire to be fixed thereto or for holding an S-hook for fastening a support wire.

### BRIEF DESCRIPTION OF THE DRAWINGS

An embodiment of the invention is described below with reference to the accompanying drawings.

FIGS. 1 and 2 are respectively a plan view and an elevation view of a crossbar of the invention.

FIG. 3 is a cross-section of an intermediate stake for receiving a crossbar.

FIG. 4 is a cross-section through an end stake.

FIG. 5 is a plan view of the assembly formed by an intermediate stake and a crossbar clipped thereto.

FIG. 6 is a general view showing all of the elements of the invention ready for training plants.

### MORE DETAILED DESCRIPTION

FIGS. 1 and 2 show an embodiment of a single-piece clip-crossbar of the invention, this shape naturally not being limiting providing the crossbar can be fixed to a stake of complementary profile by being clipped thereto.

The crossbar 10 presents an omega-shaped profile with a web constituted by a central portion 12 extended at each end by an angled portion 14 followed by a portion angled the other way and extending in the form of end limbs 16. The crossbar 10 is advantageously symmetrical, with its limbs 16 being coplanar and extending in a plane parallel to the plane of the central portion 12. Each limb has a hole 18 for receiving a support wire, the hole being open to the outside via a narrow opening 20 of width that is just sufficient to allow the wire to pass through.

The crossbar 10 is advantageously made by folding a 1.5 millimeter (mm) thick strip of resilient stainless steel. When stainless steel is used there is no need to provide any surface treatment, thereby avoiding any health risk due to contamination of the plant which is to be trained. Typical dimensions for such a crossbar are as follows: overall length 110 mm; length of central portion 47 mm; spacing L between holes 80 mm; angle of the angled portion 14 relative to the plane of the central portion 12: 55°.

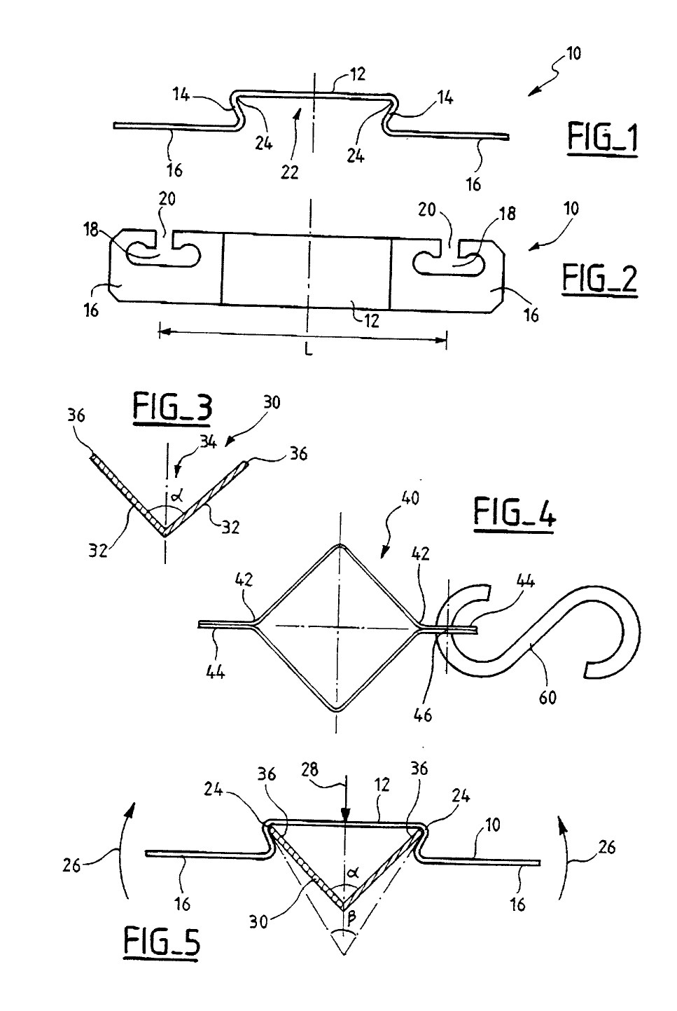

The crossbar is designed to be mounted on a stake 30 (FIG. 3) which is advantageously a simple angle section metal bar having two symmetrical flanges 32 with a dihedral angle αof 90°. The length in right section of each flange 32 is 31 mm, for example, with the bar 30 itself being made by folding a flat iron strip that is 1.5 mm thick.

The training assembly also has end stakes 40 which are placed at each end of a row of vines, the end stake presenting the profile shown in FIG. 4, i.e. a square profile with two opposite corners 42 being extended by coplanar flanges 44. At least one of these flanges has holes 46 for receiving a wire or an S-hook for fastening a wire (reference 60). Typically the section of the central square has a side of about 34 mm and its flanges 44 project by about 25 mm. As shown, an end stake can be made out of two flat irons stamped longitudinally at 90° so as to give them the desired shape, and then placed face to face and assembled together, e.g. by spot-welding.

FIG. 5 is a plan view showing a crossbar 12 mounted on the complementary stake 30: the concave side 22 of the omega shape of the crossbar 10 faces the inside region 34 of the dihedral angle formed by the stake 30, with the free ends 36 of the profile of the stake 30 being received in the inside curvature 24 of the omega shape formed between its central portion and its angled portion 14. Advantageously, for effective snap-fastening relying on elasticity, the dihedral angle a of the bar constituting the stake 30 (in this case α=90°) is greater than the angle β defined by the angled plane portions 14 (in this case β=70°).

Using this configuration, in order to install or move a crossbar 10 on a stake 30, it suffices to twist the limbs 16 of the crossbar (arrow 26) possibly while also pressing on the central portion 12 (arrow 28) which is easily done by hand and does not require any special tool.

It should also be observed that, once the crossbar has been mounted on a stake, the snap-fastening force holds the crossbar very well, preventing any undesired movement thereof, even when mechanical picking machines or systems are used that rely on imparting vibration or shaking.

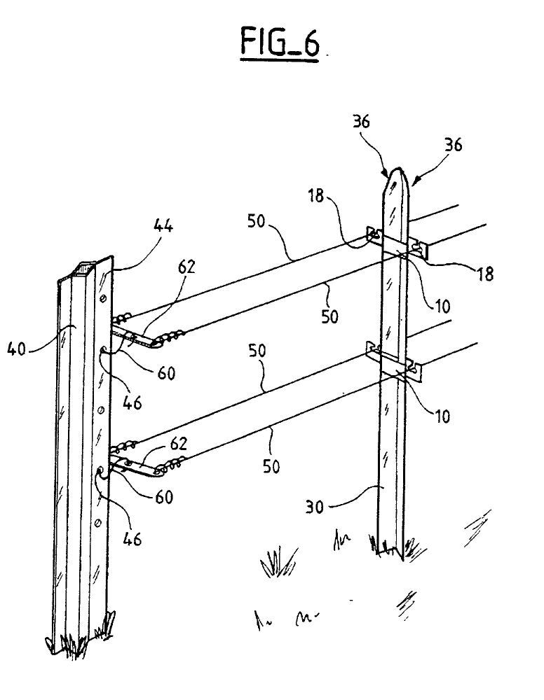

Once the training assembly has been installed, it presents the configuration shown in FIG. 6 which shows an end stake 40, an intermediate stake 30, two crossbars 10 mounted at desired heights on the intermediate stake 30, and two pairs of support wires 50. The end of each support wire 50 is fixed to a spreader 62, itself fixed to the end stake 40 by means of an S-hook 60 mounted between one of the holes 46 in the end stake and a middle hole in the spreader (in a variant it is also possible to fix two support wires 50 directly to an S-hook 60, with the wires then moving progressively further apart until they reach the supporting crossbar 10 of the first intermediate stake 30). Thereafter the support wire is received in the corresponding hole 18 of the crossbar 10 in the adjacent intermediate stake, and so on until reaching the end stake at the other end of the row of vines.

The crossbars 10 can be snap-fastened to the intermediate stakes 30 by placing them at the desired height and then by clipping them into place by applying pressure; however it is also possible, particularly for the higher crossbars, for the crossbars to be engaged over the top of the stake (thereby deforming them slightly) and then moves down to the required height by causing them to slide along the stake, with the crossbars finally being locked in place by releasing them to apply the clipping force. For this purpose, the intermediate stakes 30 advantageously have a tapering top portion 38 on each flange so as to make it easier to engage a crossbar.

The particular profile of an end stake having flanges 44 extending in the long direction of a row of vines gives the end stake very good resistance to traction which is important given the force it needs to withstand as a result of tension on the support wires. This particular profile makes it possible in particular to avoid using a bracing stake of the kind that is generally necessary with presently-used training assemblies.

The L-shaped profile of the intermediate stake 30 and the section selected for them means that they are easy to put into place and can obtain an excellent footing in loose ground, where necessary.

It will be observed that the intermediate stake 30 of the invention is set into the ground in a position such that the plane bisecting its dihedral angle lies on the direction of the row of vines. This configuration is different from that normally used with angle iron type stakes carrying crossbars that are screwed or clamped thereto: under such circumstances, it is necessary to have one of the faces of each stake (the face supporting the crossbar) extending perpendicularly to the row of vines, the other face thus lying in a plane that coincides with that of the row of vines (in the most common case of an angle section stake with two perpendicular flanges).

1/ A training assembly, in particular for vines, the assembly comprising at least two end stakes, a plurality of intermediate metal stakes, supporting crossbars mounted on the intermediate stakes, and moving or fixed support wires extending from one end stake to the other and being supported by the crossbars mounted on the intermediate stakes at heights that are adjusted to be in alignment from one stake to the next,
wherein the crossbars are single-piece crossbars, wherein the material of the crossbars is elastically deformable, and wherein the respective profiles of the crossbars and of the intermediate stakes are selected in such a manner as to enable the crossbars to be snap-fastened onto a stake, the crossbar being mounted on a stake by elastically deforming the crossbar by applying external stress thereto, and once the crossbar has been put into position at a selected height on the stake, the crossbar is held to the stake by the elastic return force once the external stress has been released.

2/ The assembly of claim 1, in which the intermediate stakes and/or the end stakes are metal bars of uniform section.

3/ The assembly of claim 2, in which the intermediate stakes are stakes presenting a symmetrical angle section.

4/ The assembly of claim 2, in which the intermediate stakes further comprise end tapers suitable for facilitating engagement of a crossbar over the end.

5/ The assembly of claim 1, in which the crossbar presents an omega-shaped section, the limbs of the omega shape including holes suitable for supporting the support wires, and the web comprising a central portion and angled portions together presenting an internal profile complementary to the internal profile of an intermediate stake.

6/ The assembly of claim 5, in which the dihedral angle of the bar constituting the intermediate stake is greater than the angle defined between the angled portions of the web of the crossbar.

7/ The assembly of claim 1, in which the end stake is a square section post extended from two opposite corners by two straight flanges projecting away from each other in a common plane, the end stake being provided in at least one of its flanges with holes suitable for enabling a support wire to be fixed thereto or for enabling a fastening S-hook for a support wire to be held.

8/ A crossbar for supporting support wire in a training assembly, in particular for training vines, the crossbar being designed to be mounted at a predetermined height on a stake, wherein the crossbar comprises a single piece, wherein the crossbar is made out of an elastically deformable material, and wherein the crossbar presents, relative to the profile of the stake a complementary profile selected in such a manner as to enable the crossbar to be snap-fastened onto the stake, the crossbar being mounted on the stake by elastically deforming the bar under external stress and, once the bar has been put into position at the selected height on the stake, the bar is held to the stake by the elastic return force after the external stress has been released.

9/ The crossbar of claim 1, presenting an omega-shaped section, the limbs of the omega shape having holes suitable for supporting the support wires, and the web thereof comprising a central portion and angled portions together presenting an internal profile complementary to the internal profile of the stake.

10/ The crossbar of claim 9, in which the angle defined by the angled portion of the web is smaller than the dihedral angle of the bar constituting the stake.
